(19) United States
(12) Patent Application Publication
(10) Pub. No.: US 2017/0337205 A1
(43) Pub. Date: Nov. 23, 2017

(54) Geospatial Web Crawler Architecture

(71) Applicant: National Central University, Taoyuan City (TW)

(72) Inventors: Chih-Yuan Huang, Taoyuan City (TW); Hao Chang, Hsinchu County (TW)

(21) Appl. No.: 15/157,602

(22) Filed: May 18, 2016

(51) Int. Cl. G06F 17/30; G06F 17/22; H04L 29/08

(52) U.S. Cl. CPC G06F 17/3087; H04L 67/18; H04L 67/02; G06F 17/30887; G06F 17/2235; G06F 17/30241; G06F 17/30061; G06F 17/30864

(57) ABSTRACT

Architecture for searching geospatial resources is provided. Geospatial web crawlers are used. The architecture comprises a database, a plurality of computers (workers) and a server (master). The master is connected with the database and the workers. By using the concept of web crawler and parallel processing, geospatial resources shared on the Internet can be automatically and quickly found in a large scale. Thus, geospatial resources can be collected with high efficiency. A complete and rich geospatial database can be established. The problem of quickly finding resources in the Big Geoweb Data can be solved.

### TECHNICAL FIELD OF THE INVENTION

The present invention relates to geospatial resource; more particularly, relates to concepts of web crawlers and parallel processing for large-scaled, automatically and quickly searching all kinds of geospatial resources shared on the Internet to highly efficiently collect the geospatial resources and thereby establish a complete and rich geospatial database for solving the problem of how to quickly and efficiently search resources in the Big Geoweb Data.

### DESCRIPTION OF THE RELATED ARTS

Geographic data, such as maps, aerial photographs, and satellite images, are often used in different fields to assist in designs, statistics, decision-making and all kinds of scientific researches of administrative management, political and economic analysis, etc. With the development of world-wide web (WWW), Web 2.0 describes the concept that all users will be able to publish data or web services on the Internet. Many of today's popular web services have the concept of Web 2.0, such as social networking sites (e.g. Facebook, Twitter, Google+), blogs (such as Tumblr, WordPress), media sharing services (such as YouTube, Flickr), encyclopedia (such as Wikipedia), etc. Therein, if the information or services on the web carries geographic information, the whole cluster of the data and services is defined as a geospatial web (GeoWeb), and the data and services are defined as resources. Through the global coverage provided by the Internet, any user can link to and use the geographic information and services on the GeoWeb. The most famous web service is the web mapping service, such as Google Maps proposed by Google in the year of 2005. Because a geospatial coordinates can be used as architecture for integrating data, GeoWeb not only strengthens the reusability of geographic data, but also combines information of different fields for multi-faceted comprehensive analysis. But, just like the WWW, GeoWeb also faces difficulties in resource searching.

Now, with the rapid development of the Internet, the amount of data is accumulated rapidly, and thus the era of big data is formed. However, on facing such a huge amount of data, how to efficiently obtain the information we want has become an important issue.

Hence, the prior arts do not fulfill all users' requests on actual use.

### SUMMARY OF THE INVENTION

The main purpose of the present invention is to use concepts of web crawlers and parallel processing for large-scaled, automatically and quickly searching all kinds of geospatial resources shared on the Internet to highly efficiently collect the geospatial resources and thereby establish a complete and rich geospatial database for solving the problem of how to quickly and efficiently search resources in the Big Geoweb Data.

The secondary purpose of the present invention is to provide a main method of finding geospatial resources for thereby developing geographic web search engine in the future.

To achieve the above purposes, the present invention is architecture using geospatial web crawler, comprising a database, a plurality of computers (workers), and a server (master), where the workers simultaneously identify geospatial resources and crawl webs with new uniform resource locators (URL) and the geospatial resources fed back at any time; each one of the workers has a web crawler assigned with a seed web page as a starting point of crawling; source code of the seed web page is downloaded to be parsed out all hyperlinks contained within; whether any one of the hyperlinks is linked to a catalogue service or not is judged; if the one of the hyperlinks is linked to a catalogue service, geospatial resources within the one of the hyperlinks is crawled; if none of the hyperlinks is linked to a catalogue service, the web crawler links to the hyperlinks to download source codes of web pages of the hyperlinks to parsed out all hyperlinks contained within, repeatedly; the master is connected to the database and the workers; the master receives the new URLs and the geospatial resources fed back from the workers and stores the geospatial resources in the database; and, simultaneously, results thus crawled are aggregated to re-assign new tasks to the workers. Accordingly, novel architecture using geospatial web crawler is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention; and

FIG. 2 is the view showing the use flow of the preferred embodiment.

### DESCRIPTION OF THE PREFERRED EMBODIMENT

The following description of the preferred embodiment is provided to understand the features and the structures of the present invention.

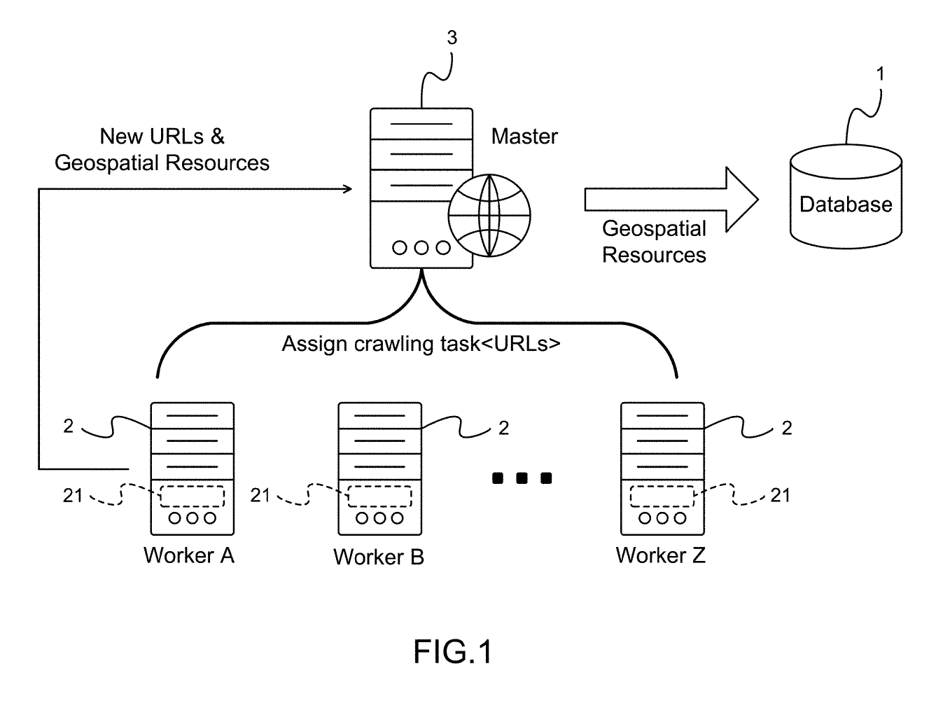

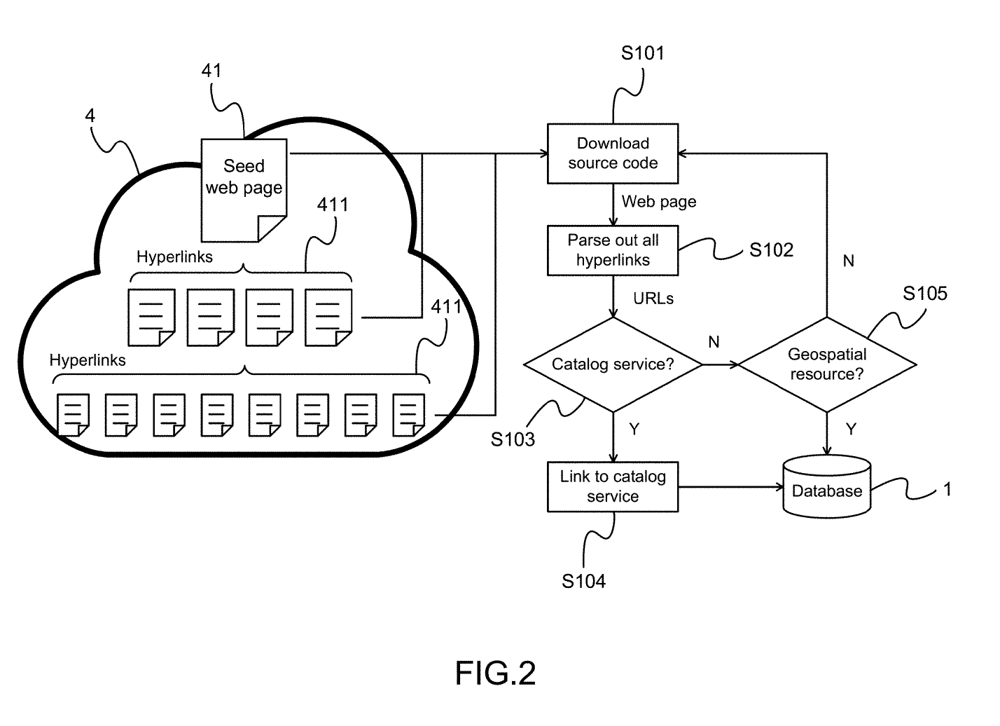

Please refer to FIG. 1 and FIG. 2, which are a structural view showing a preferred embodiment according to the present invention; and a view showing a use flow of the preferred embodiment. As shown in the figures, the present invention is geospatial web crawler architecture, where web crawlers and parallel processing are used to large-scaled and automatically search geospatial resources shared on the Internet. The architecture comprises a database 1, a plurality of computers (workers) 2 and a server (master) 3.

The workers 2 simultaneously identify geospatial resources and crawl webs with new uniform resource locators (URL) and the geospatial resources fed back to the master 3 at any time. Each of the workers 2 has a web crawler 21.

The master 3 is connected to the database 1 and the workers 2. The master 3 receives the new URLs and the geospatial resources fed back from the workers 2; and stores the geospatial resources in the database 1. Simultaneously, results thus crawled are aggregated to re-assign new tasks to the workers 2 by the master 3.

Thus, novel architecture using geospatial web crawler is obtained.

On using the present invention, the workers 2 are assigned with crawling tasks through the master 3. A seed web page 41 on the Internet is used as a starting point of crawling for the web crawler 21 of each of the workers 2. The seed web page 41 is a search page of a search engine like Google, Yahoo, Bing or Yam. In step S101, source code of the seed web page 41 is downloaded; and, in step S102, all hyperlinks 411 contained within the seed web page 41 are parsed out. Then, in step S103, whether any one of the hyperlinks 411 is linked to a catalogue service or not is judged. If yes, in step S104, the one of the hyperlinks 411 is linked for crawling out geospatial resources contained within to be stored in the database 1. If not, in step S105, whether any one of the hyperlinks 411 is linked to a geospatial resource or not is judged. If none of the hyperlinks 411 is linked to a geospatial resource, the web crawler 21 links to web pages of the hyperlinks 411 and backs to step S101 to download source codes of the web pages of the hyperlinks to parsed out all hyperlinks contained within, repeatedly.

During crawling, the proposed architecture of the present invention identifies and collects geospatial resources on the Internet. For identifying geospatial resources, the present invention follows international open standards of geospatial resources, such as the geospatial web services developed by Open Geospatial Consortium (Open Geospatial Consortium, OGC), comprising sensor observation service (SOS), web map service (WMS), web feature service (WFS), web coverage service (WCS), web map tile service (WMTS), web processing service (WPS) and catalogue service for the web (CSW). These open standards provide different geospatial resources on the Internet for users to use through interfacing; and geographic data standards such as OGC's keyhole markup language (KML) and ESRI shapefile format. The architecture using geographic web crawler proposed by the present invention may further comprises a communication protocol (e.g. web portal, catalogue service) of a geospatial resource platform proprietarized by a third party to include resources of the communication protocol as a scope to be crawled for collecting complete geographic web resources.

In addition, for improving network performance and scalability of the web crawlers, the present invention uses parallel processing by simultaneously using the web crawlers in a plurality of computers, which enhances crawling efficiency by expanding crawling scale. In FIG. 1, the workers 2 simultaneously identify geospatial resources by crawling the Internet and feed back new URLs and the geospatial resources to the master 3 at any time. The master 3 aggregates results thus crawled to re-assign new tasks to the workers 2. By increasing the number of the workers 2, the effectiveness of the overall architecture using the web crawlers can also be increased.

The present invention relates to geospatial resources with architecture using geospatial web crawler to collect geographic data for solving the problem of how to quickly and efficiently search resources in the Big Geoweb Data. Consequently, the present invention can automatically search various types of geospatial resources for about ten times of resources found more than those found through any existing technology. Thus, the present invention can be used as a main method of finding geospatial resources for thereby developing geographic web search engine in the future. Because the establishment of a complete database is the most essential for a search engine, the present invention uses the concepts of web crawler and parallel processing to highly efficiently collect geospatial resources for the establishment of a complete geographic network database. Thus, the search engine developed according to the present invention will provide users to quickly search geospatial information for obtaining major breakthrough in the geospatial information field.

To sum up, the present invention is architecture using geospatial web crawler, where web crawlers and parallel processing are used to large-scaled and automatically search geospatial resources shared on the Internet and thereby build a complete and rich geographic network database for solving the problem of how to quickly search resources in the Big Geoweb Data.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. Architecture using geospatial web crawler, said architecture using web crawlers and parallel processing to large-scaled and automatically search geospatial resources shared on the Internet, said architecture comprising
a database;
a plurality of computers (workers), said workers simultaneously identifying geospatial resources and crawling webs with new uniform resource locators (URL) and said geospatial resources fed back,
wherein each one of said workers has a web crawler assigned with a seed web page as a starting point of crawling; source code of said seed web page is downloaded to be parsed out all hyperlinks contained within; whether any one of said hyperlinks is linked to a catalogue service or not is judged; if said one of said hyperlinks is linked to a catalogue service, geospatial resources within said one of said hyperlinks is crawled; and, if none of said hyperlinks is linked to a catalogue service, said web crawler links to said hyperlinks to download source codes of web pages of said hyperlinks to parsed out all hyperlinks contained within, repeatedly; and
a server (master), said master being connected to said database and said workers,
wherein said master receives said new URLs and said geospatial resources fed back from said workers and stores said geospatial resources in said database; and, simultaneously, results thus crawled are aggregated to re-assign new tasks to said workers by said master.

2. The architecture according to claim 1,
wherein said workers identify said geospatial resources according to international open standards of geospatial resources; and
wherein said international standards are developed by open geospatial consortium (OGC) and comprises a plurality of geospatial web services and a plurality of geospatial data standards.

3. The architecture according to claim 2,
wherein said geospatial web services comprises sensor observation service (SOS), web map service (WMS), web feature service (WFS), web coverage service (WCS), web map tile service (WMTS), web processing service (WPS) and catalogue service for the web (CSW).

4. The architecture according to claim 2,
wherein said geospatial data standards comprises keyhole markup language (KML) and ESRI shapefile format.

5. The architecture according to claim 1,
wherein said architecture further comprises a communication protocol of a geospatial resource platform proprietarized by a third party to include resource of said communication protocol as a scope to be crawled.

6. The architecture according to claim 1,
wherein said seed web page is a search page of a search engine.

7. The architecture according to claim 1,
wherein said search engine is selected from a group consist of Google, Yahoo, Bing and Yam.
